(19) United States
(12) Patent Application Publication
(10) Pub. No.: US 2008/0112715 A1
(43) Pub. Date: May 15, 2008

(54) Image Forming Apparatus and Method of Determining Life of Toner Cartridge

(75) Inventors: Toshiki SHIROKI, Shiojiri-shi (JP); Hidenori KIN, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 11/925,429

(22) Filed: Oct. 26, 2007

(30) Foreign Application Priority Data
Oct. 27, 2006 (JP) 2006-292412

(51) Int. Cl. G03G 15/08

(52) U.S. Cl. 399/27

(57) ABSTRACT

An image forming apparatus includes a toner cartridge that is configured to be detachably attachable to a main body of the image forming apparatus and stores toner, a cartridge memory unit that is provided in the toner cartridge and stores information on the toner cartridge, an image forming unit that forms a toner image using toner supplied from the toner cartridge, a memory determining unit that determines whether the cartridge memory unit is in a normal state, a count unit that counts an amount of toner consumption consumed for the toner image formed by the image forming unit, and a life determination unit that determines the life of the toner cartridge corresponding to an amount of residual toner remaining in the toner cartridge, wherein the life determination unit shifts its mode between a first life-determination mode in which the life is determined on the basis of a count value of the count unit and a second life-determination mode in which the life is determined on the basis of the toner density of a toner image used as a patch image formed by the image forming unit, on the basis of the result of determination of the memory determining unit.

### BACKGROUND

1. Technical Field

The present invention relates to an image forming apparatus and a method of determining the life of a toner cartridge in which a toner image using a toner cartridge configured to be detachably attachable to a main body of the image forming apparatus is formed.

2. Related Art

In electro-photographic image forming apparatuses such as printers, copiers, and facsimile equipments which form an image using toner, it is required to acquire the amount of toner consumption or the amount of residual toner regarding the life of a toner cartridge for a maintenance operation such as replacement of the toner cartridge. Thus, technology (hereinafter, referred to as toner counting technology) for acquiring the amount of toner consumption with high precision has been proposed. For example, in a method of detecting the amount of toner consumption disclosed in JP-A-2002-174929 (FIG. 2), print dot arrays are classified into a plurality of patterns depending on their types of dot continuation, and the numbers of occurrences of the plurality of patterns are counted. Then, by multiplying the count numbers by predetermined coefficients and summing the results of multiplication, the total amount of toner consumption is calculated. In this way, the amount of toner consumption with high precision is acquired regardless of non-linearity between the number of dots that varies depending on a difference between the types of dot continuation and the amount of toner attachment. In addition, for example, in apparatuses disclosed in JP-A-2004-354666 (FIG. 3) and JP-A-2006-284669 (FIG. 3), the amount of residual toner is determined with high precision by using the amount of toner consumption calculated using the toner counting technology and the result of density detection of a toner image used as a patch image.

In these types of image forming apparatuses, cartridge memories for storing information on a toner cartridge such as an initial value of the amount of toner stored in the toner cartridge are provided. In the above-described general toner counting technologies, the amount of residual toner is acquired on the basis of the initial value stored in the cartridge memory. However, when an error such as a read error in the cartridge memory occurs, the life of the ink cartridge cannot be determined precisely by using the general toner counting technologies. In addition, it is more preferable for a user to use the toner cartridge as long as the toner therein remains, instead of being unable to use it, even when a problem occurs in the cartridge memory.

However, in apparatuses disclosed in above-described JP-A-2002-174929, JP-A-2004-354666, and JP-A-2006-284669, a case where an error occurs in the cartridge memory is not considered. Thus, in a state in which an error occurs in the cartridge memory and the life of the toner cartridge cannot be determined precisely, when an image defect such as a thin spot or insufficient density in an image due to a decrease in the amount of residual toner occurs while a large quantity of images are consecutively formed, recording paper and a processing time are wasted unnecessary.

### SUMMARY

An advantage of some aspects of the invention is that it provides an image forming apparatus and a method of determining the life of a toner cartridge which are capable of determining the life of a toner cartridge even in a case where an error occurs in the cartridge memory.

According to a first aspect of the invention, there is provided an image forming apparatus including: a toner cartridge that is configured to be detachably attachable to a main body of the image forming apparatus and stores toner; a cartridge memory unit that is provided in the toner cartridge and stores information on the toner cartridge; an image forming unit that forms a toner image using toner supplied from the toner cartridge; a memory determining unit that determines whether the cartridge memory unit is in a normal state; a count unit that counts an amount of toner consumption consumed for the toner image formed by the image forming unit; and a life determination unit that determines the life of the toner cartridge corresponding to an amount of residual toner remaining in the toner cartridge. The life determination unit shifts its mode between a first life-determination mode in which the life is determined on the basis of a count value of the count unit and a second life-determination mode in which the life is determined on the basis of the toner density of a toner image used as a patch image formed by the image forming unit, on the basis of the result of determination of the memory determining unit.

According to a second aspect of the invention, there is provided a method of determining the life of a toner cartridge using an image forming apparatus that has a toner cartridge configured to be detachably attachable to a main body of the image forming apparatus and store toner and a cartridge memory unit provided in the toner cartridge and storing information on the toner cartridge and forms a toner image using toner supplied from the toner cartridge. The method includes: determining whether the cartridge memory unit is in a normal state; counting an amount of toner consumption consumed for forming the toner image; and determining the life of the toner cartridge corresponding to an amount of residual toner remaining in the toner cartridge. The determining of the life shifts its mode between a first life-determination mode in which the life is determined on the basis of a count value acquired by the counting of the amount of toner consumption and a second life-determination mode in which the life is determined on the basis of the toner density of a toner image formed as a patch image, on the basis of the result of determination of the determining of a state of the cartridge memory.

According to the image forming apparatus and the method of determining the life of a toner cartridge, in the toner cartridge that is configured to be detachably attachable to the main body of the image forming apparatus and stores toner, the cartridge memory unit for storing information on the toner cartridge is provided so as to determine whether the cartridge memory unit is in a normal state. Then, a toner image is formed with toner supplied from the toner cartridge, the amount of toner consumption consumed for forming the toner image is counted, and an operation for determining the life of the toner cartridge corresponding to the amount of residual toner remaining in the toner cartridge is performed. Here, a mode for determining the life is shifted between a first life-determination mode in which the life is determined on the basis of a count value of the amount of toner consumption and a second life-determination mode in which the life is determined on the basis of the density of a toner image formed as a patch image, on the basis of the result of determination on whether the cartridge memory unit is in a normal state, and an operation for determining the life is performed. Thus, for example, even in a case where the determination of life in the first life-determination mode cannot be performed, it is possible to determine the life by using the second life-determination mode. Accordingly, the toner cartridge can be used continuously regardless of an occurrence of an error in the cartridge memory unit, and it is possible to urge a user to replace the toner cartridge when the life is determined to be over by using the first life-determination mode or the second life-determination mode.

The memory determining unit may perform the determination by a CRC checking operation, a read-out checking operation, and a write checking operation, and the life determination unit may perform the life determination operation by using the first life-determination mode in a case where the memory determining unit determines that the results of all the checking operations are normal or there is an error only in the result of the write checking operation, and perform the life determination operation by using the second life-determination mode in a case where the memory determining unit determines that there is an error in the result of the CRC checking operation or the result of the read-out checking operation.

In such a case, it is determined whether the cartridge memory unit is in a normal condition by performing the CRC (Cyclic Redundancy Check) checking operation, the read-out checking operation, and the write checking operation for the cartridge memory unit. When the memory determining unit determines that the cartridge memory unit is in a normal condition or there is an error only in the write checking operation, a value stored in the cartridge memory unit can be read out and used, and accordingly, it is possible to appropriately determine the life by using the first life-determination mode. On the other hand, when the memory determining unit determines that there is an error in the CRC checking operation, there is a high probability that a value stored in the cartridge memory unit changes to an unreliable value. In addition, when it is determined that there is an error in the read-out checking operation, a value stored in the cartridge memory unit cannot be read out for being used. Thus, in such cases, it is possible to appropriately determine the life by using the second life-determination mode.

The life determination unit may determine a timing for performing the life determining operation in the second life-determining mode on the basis of the amount of toner consumption. In such a case, since the timing for performing the life determining operation in the second life-determining mode is determined on the basis of the amount of toner consumption, it is possible to appropriately performing the life determination. As a value corresponding to the amount of toner consumption, for example, a count value of the amount of toner consumption, an accumulated operating time of the toner cartridge, the number of formed toner images, or the like may be used.

When the life determination unit shortens an interval for performing the life determining operation in the second life-determination mode as a value corresponding to the amount of toner consumption increases, the frequency of life determination becomes high as the end of the life is approached, and accordingly, it is possible to assuredly prevent an occurrence of an image defect such as an occurrence of thin spots in the formed toner image due to the end of the life.

The life determination unit may not perform the life determining operation after determining that the life is over as the result of the life determining operation in the second life-determination mode. In the second life-determination mode, the life is determined on the basis of the density of a formed path image, and thus, when it is determined that the life is over by using the second life-determination mode, there is a high probability that there is scarcely residual toner. Accordingly, in such a case, it is possible to prevent performing a useless life determination operation, in which a patch image is formed, in advance.

The image forming apparatus may further include a density control unit that performs a density control operation for adjusting an operation parameter of the image forming unit which has an effect on the density of the toner image on the basis of the density of a patch image when the life determination unit performs the life determination operation in the second life-determination mode and thus, the patch image is formed by the image forming unit. In such a case, the formed path image can be commonly used for the life determination operation and the density control operation.

The main body of the image forming apparatus may be configured such that a plurality of toner cartridges can be built therein, and the memory determining unit may determine whether the cartridge memory unit is in a normal state for each toner cartridge, and the life determination unit may shifts between the first life-determination mode and the second life-determination for each toner cartridge on the basis of the result of determination performed by the memory determining unit. In such a case, it is possible to determine the life in appropriate life determination modes for each toner cartridge on the basis of the state of the cartridge memory unit. In other words, for example, the first life-determination mode is used for a toner cartridge corresponding to a normal cartridge memory unit, and a patch image is not formed for the life determination operation, and accordingly, there is an advantage that toner is not consumed for the life determination operation.

### BRIEF DESCRIPTION OF THE DRAWINGS

The invention will be described with reference to the accompanying drawings, wherein like numbers reference like elements.

FIG. 1 is an image forming apparatus according to an embodiment of the present invention.

FIG. 2 is a block diagram showing the electrical configuration of the image forming apparatus shown in FIG. 1.

FIGS. 3A, 3B, and 3C are diagrams showing stop positions of a developing unit.

FIG. 4 is a flowchart showing an operation at a time when a developer is installed.

FIG. 5 is a flowchart showing a subroutine for a memory checking process shown in FIG. 4.

FIG. 6 is a flowchart showing read and write operations for a memory chip.

FIG. 7 is a flowchart showing a subroutine for a first life-determination mode shown in FIG. 6.

FIG. 8 is a flowchart showing a subroutine for a second life-determination process shown in FIG. 6.

FIG. 9 is a flowchart showing a subroutine for the second life-determination mode shown in FIG. 8.

FIG. 10 is a diagram showing a relationship between a development bias and an image density.

FIG. 11 is a flowchart showing a subroutine for a density control operation shown in FIG. 9.

### DESCRIPTION OF EXEMPLARY EMBODIMENTS

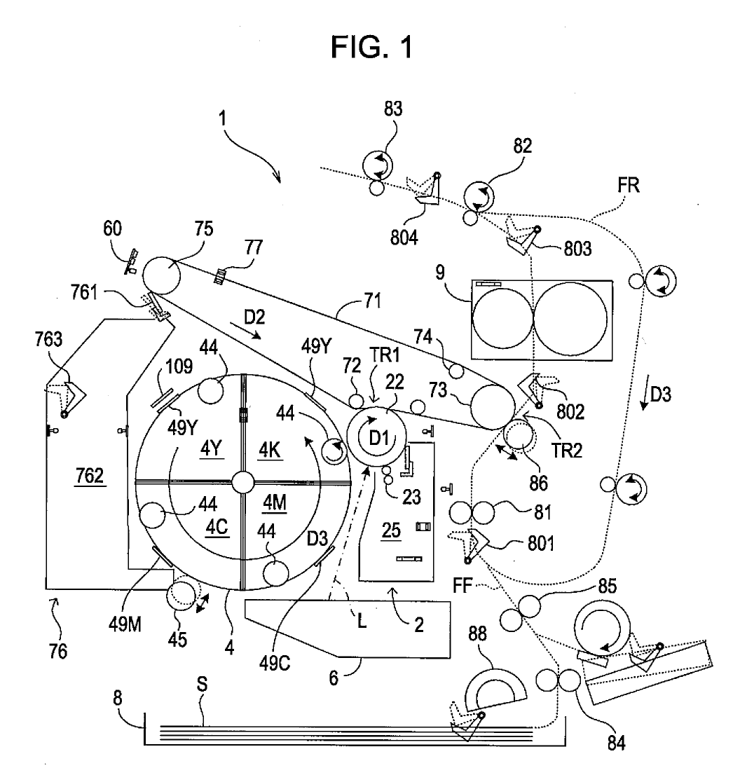

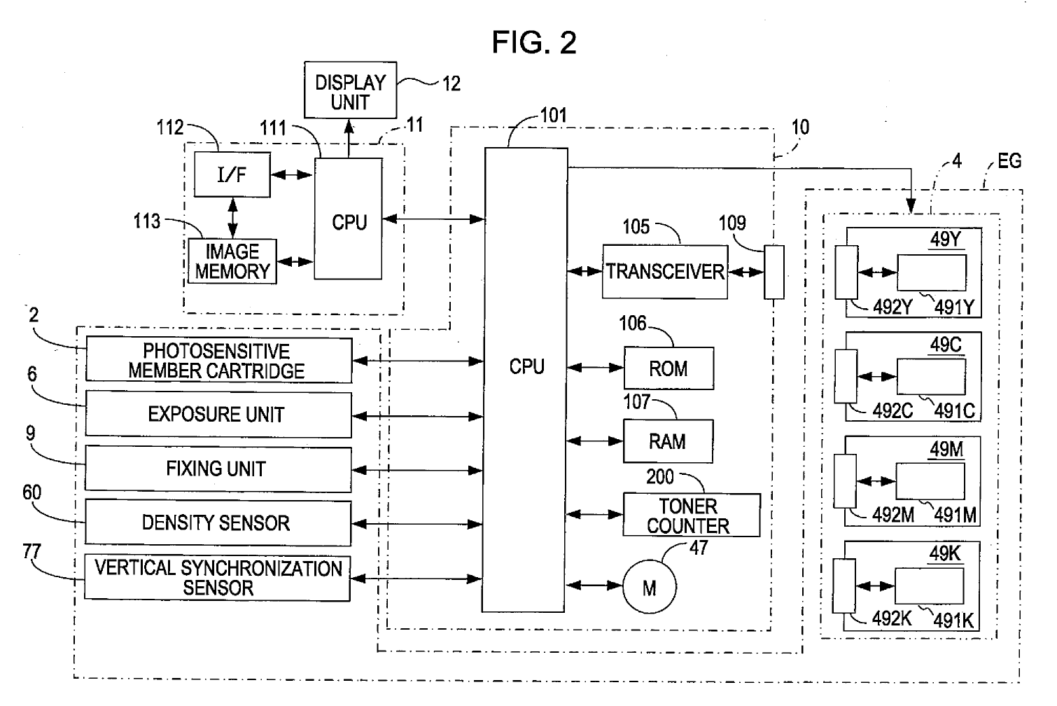

FIG. 1 is an image forming apparatus according to an embodiment of the present invention. FIG. 2 is a block diagram showing the electrical configuration of the image forming apparatus shown in FIG. 1. This image forming apparatus forms a full-color image by superposing four color toner (developer) of yellow (Y), cyan (C), magenta (M), and black (K), or forms a monochrome image by using only black (K) toner. In the image forming apparatus, when an image signal is input to a main controller 11 from an external device such as a host computer, a CPU 101 provided in an engine controller 10 controls parts of an engine unit EG in accordance with a command sent from the main controller 11 and performs predetermined image forming operations, thereby forming an image corresponding to the image signal on a sheet S.

This engine unit EG is provided with a photosensitive member 22 such that the photosensitive member is rotatable in the direction of an arrow D1 shown in FIG. 1. A charge roller 23, a rotary developing unit 4, and a cleaning unit 25 are disposed around the photosensitive member 22 along the rotating direction D1 thereof. A predetermined charging bias is applied to the charge roller 23, and thereby charging an outer peripheral surface of the photosensitive member 22 to a predetermined surface potential. The cleaning unit 25 removes toner adhering to the surface of the photosensitive member 22, which remains after first transfer is performed, and collects the removed toner into a waste toner tank provided therein. The photosensitive member 22, the charge roller 23, and the cleaning unit 25 integrally form a photosensitive member cartridge 2, and the photosensitive member cartridge 2 can be detachably attached to a main body 1 of the image forming apparatus as a whole.

A light beam L is emitted from an exposer unit 6 toward the outer peripheral surface of the photosensitive member 22 charged by the charge unit 23. In accordance with an image signal transmitted from an external device, the exposer unit 6 emits the light beam L on the photosensitive member 22, and thereby forming an electrostatic latent image corresponding to the image signal.

The thus-formed electrostatic latent image is developed with toner by the developing unit 4. In particular, the developing unit 4 of the image forming apparatus has a support frame 40 that is provided so as to be rotatable around the center of a rotation shaft that is orthogonal to the paper surface of FIG. 1 and a yellow developer 4Y, a cyan developer 4C, a magenta developer 4M, and a black developer 4K which are configured as cartridges detachably attached to the support frame 40 and each of which stores one non-magnetic toner component for a corresponding color. The developing unit 4 is driven to rotate by a developing unit driving motor 47 that is a stepping motor controlled by the engine controller 10. In addition, in the main body 1 of the image forming apparatus, a rotary lock 45 that can be brought into contact with or be spaced apart from the developing unit 4 is provided. The rotary lock 45 is brought into contact with the outer peripheral surface of the support frame 40 of the developing unit 4 as is required for serving as a braking and locking mechanism that determines a stop position of the developing unit 4 to be a predetermined position by restricting the rotation of the developing unit 4.

When the developing unit 4 is driven to rotate and the developers 4Y, 4C, 4M, and 4K are selectively positioned in a predetermined position for opposing the photosensitive member 22, in accordance with a control command output from the engine controller 10, a developing roller 44 that is provided in the selected developer and supports the toner of the selected color is disposed to oppose the photosensitive member 22 with a predetermined gap therebetween and imparts toner on the surface of the photosensitive member 22 from the developing roller 44 disposed in the opposing position. As a result, the electrostatic latent image on the photosensitive member 22 is rendered visible in the selected color of toner.

In other words, a toner layer formed on the surface of the developing roller 44 is sequentially transported to the position for opposing the photosensitive member 22, on a surface of which the electrostatic latent image is formed, in accordance with rotation of the developing roller 44. Then, when a development bias is applied to the developing roller 44 by the engine controller 10, the toner supported by the developing roller 44 is partially adhered to parts of the surface of the photosensitive member 22 depending on the surface potential thereof, and thereby the electrostatic latent image on the photosensitive member 22 is rendered visible in the selected color of toner.

The toner image developed by the developing unit 4, as described above, is transferred to an intermediate transfer belt 71 of a transfer unit 7 in a first transfer area TR1 as first transfer. The transfer unit 7 includes the intermediate transfer belt 71 suspended on a plurality of rollers 72 to 75 and a drive section (not shown) for circulating the intermediate transfer belt 71 in a predetermined rotating direction D2 by rotating the roller 73. When a color image is to be transferred on a sheet S, a color image is formed by superposing toner images of each color formed on the photosensitive member 22 on the intermediate transfer belt 71 and the color image is transferred on the sheet S, which has been taken out of a cassette 8 and transported to a second transfer area TR2 along a transport path FF, as second transfer.

The second transfer area TR2 is a nip portion in which the surface of the intermediate transfer belt 71 suspended on the roller 73 and a second transfer roller 86 that is brought into contact with or spaced apart from the surface of the intermediate transfer belt are brought into contact with each other. The sheets S that are piled so as to be stored in the cassette 8 are taken out one by one by rotation of a pickup roller 88 and loaded in the transport path FF. The loaded sheet is transported to the second transfer area TR2 along the transport path FF by rotation of feed rollers 84 and 85 and a gate roller 81.

At this moment, in order to correctly transfer the image on the intermediate transfer belt 71 in a predetermined position on the sheet S, a timing for sending the sheet S to the second transfer area TR2 is controlled. A detailed description of the timing management will be followed. The gate roller 81 is provided on the front side of the second transfer area TR2 in the transport path FF, and a before-gate sheet detecting sensor 801 is provided on the front side of the gate roller. When arrival of the sheet S transported in the transport path FF is detected by the before-gate sheet detecting sensor 801, transport of the sheet S is temporarily stopped and the rotation of the gate roller 81 is resumed in synchronization with circular movement of the intermediate transfer belt 71, and thereby the sheet S is transported to the second transfer area TR2 at a predetermined timing. The toner image formed on the intermediate transfer belt 71 is transferred on the surface of the sheet S passing through the second transfer area TR2 as the second transfer.

On the sheet S on which the color image is formed, a toner image is fixed by a fixing unit 9, and the sheet is transported to a discharge tray unit 89 provided on the top face of the image forming apparatus 1 through a before-discharge roller 82 and the discharge roller 83. In addition, when images are to be formed on both sides of the sheet S, the rotation direction of the discharge roller 83 is reversed at a time when a rear end portion of the sheet S, on one side of which the image is formed is transported to a reverse position PR on a rear side of the before-discharge roller 82, and thereby the sheet S is transported in the direction of an arrow D3 along a reverse transport path FR. Then, the sheet is loaded in the transport path FF prior to the gate roller 81, and at this moment, the side of the sheet S which is brought into contact with the intermediate transfer belt 71 in the second transfer area TR2 and on which an image is transferred is opposite the side having the image being transferred thereon beforehand. Accordingly, images can be formed on both sides of the sheet S.

In positions in the sheet transport path FF and the reverse transport path FR, sheet detecting sensors 802 to 804 for detecting pass of the sheet in the paths are provided in addition to the above-described before-gate sheet detecting sensor 801, and, on the basis of outputs of the sensors, a timing for sheet transport is controlled and jam detection for each position is performed.

A cleaner 76 is arranged in the vicinity of the roller 75. This cleaner 76 includes a cleaner blade 761 that can be retractably brought into close contact with the roller 75 by an electromagnetic clutch not shown in the figure and a waste toner tank 762. In a statue in which the cleaner blade is moved on the roller 75 side, the cleaner blade 761 is brought into contact with the surface of the intermediate transfer belt 71 suspended on the roller 75, thereby removing remaining toner, which adheres to the outer peripheral surface of the intermediate transfer belt 71, after the second transfer operation for scraping and falling the remaining toner is performed. The scraped and fallen toner is accumulated in the waste toner tank 762. In the waste toner tank 762, a waste toner sensor 763 for detecting whether the tank is full is provided.

When an image is transferred to the sheet S in the second transfer area TR2, the cleaner blade 761 is controlled to be apart from or brought into contact with the intermediate transfer belt 71 for removing the remaining toner adhering to the intermediate transfer belt 71 during a circulation for the second transfer. Thus, for example, when the image forming apparatus consecutively forms black-and-white images, an image transferred to the intermediate transfer belt 71 in the first transfer area TR1 is immediately transferred to the sheet S in the second transfer area TR2, and thus, the cleaner blade 761 is maintained to be in contact with the intermediate transfer belt. On the other hand, when a color image is to be formed, it is required to place the cleaner blade 761 to be apart from the intermediate transfer belt 71 while toner images of each color are superposed with one another. A full color image is formed by superposing the toner images of each color, and the cleaner blade 761 is brought into contact with the intermediate transfer belt 71 so as to remove the remaining toner during the circulation for the second transfer.

Around the roller 75, a density sensor 60 and a vertical synchronization sensor 77 are disposed. The density sensor 60 is disposed so as to oppose the surface of the intermediate transfer belt 71, and the density sensor measures the image density of the toner image formed on the outer peripheral surface of the intermediate transfer belt 71 as is necessary. In the image forming apparatus, an operation for adjustment of operating conditions for parts thereof which have effects on an image quality, for example, an operation for adjusting development bias, the intensity of a light beam L, and the like for the developers is performed on the basis of the result of the measurement of the image density. The density sensor 60 is configured to output a signal corresponding to an image density of a predetermined area on the intermediate transfer belt 71, for example, by using a refection type photo sensor. The CPU 101 periodically samples an output signal from the density sensor 60 while circulating and moving the intermediate transfer belt 71, so that image densities of parts of the toner images on the intermediate transfer belt 71 can be detected.

The vertical synchronization sensor 77 is used for detecting a reference position of the intermediate transfer belt 71 and serves as a sensor for acquiring a synchronization signal output in association with circulation of the intermediate transfer belt 71, that is, a vertical synchronization signal Vsync. In this image forming apparatus, operations of the parts thereof are controlled in accordance with the vertical synchronization signal Vsync so as to matching operation timings of the parts to one another and accurately superpose the toner images formed in each color.

To outer peripheral surfaces of developers 4Y, 4C, 4M, and 4K corresponding to a side surface of the developing unit 4 that integrally forms an approximate cylinder form, memory tags 49Y, 49C, 49M, and 49K are attached. For example, the memory tag 49Y installed to the yellow developer 4Y includes a memory 491Y for storing data about a production lot or usage history of the developer, the amount of residual toner installed therein, and the like and a loop antenna 492Y that is electrically connected to the memory. In the memory tags 49C, 49M, and 49K provided in other developers, memory chips 491C, 491M, and 491K and loop antennas 492C, 492M, and 492K are provided.

On the main body 1 side of the image forming apparatus, an antenna 109 for wireless communication is provided. This antenna 109 is driven by the CPU 101 and a transceiver 105. The antenna 109 communicates with an antenna for wireless communication on the developer side for data communication between the CPU 101 and the memory provided in the developer, thereby performing management of various types of information including management of expendable supplies of the developer.

As shown in FIG. 2, the image forming apparatus includes a display unit 12 controlled by a CPU 111 of the main controller 11. The display unit 12, for example, includes a liquid crystal display and displays predetermined messages for indicating operation guide, a status of an image forming operation, an occurrence of an error in the image forming apparatus, or a replacement timing for a unit, or the like to a user in accordance with a control command transmitted from the CPU 111.

In FIG. 2, a reference numeral 113 denotes an image memory provided in the main controller 11 for storing an image provided through an interface 112 from an external device such as a host computer. In addition, a reference numeral 106 denotes a ROM for storing a calculation program executed by the CPU 101, control data for controlling the engine unit EG, or the like, and a reference numeral 107 denotes a RAM for temporarily storing a result of an operation of the CPU 101 or other data.

In addition, a reference numeral 200 denotes a toner counter used for acquiring the amount of toner consumption. The toner counter 200 calculates the amounts of toner consumption for each color in accompaniment with an image forming operation and stores the amounts of toner consumption. The method of calculating the amount of toner consumption is not limited to a specific method, and various known technologies can be applied to the method. For example, an image signal input from an external device is analyzed, the numbers of toner dots formed for each toner color are counted, and the amounts of toner consumption can be calculated from the counted value. The CPU 101 can acquire the amounts of residual toner inside the developers at a time point by subtracting the amounts of toner consumption for each color acquired by the toner counter 200 from initial values of the amounts of toner stored in each developer 4Y or the like. Then, the CPU 101 displays a message in the display unit 12 for indicating the amounts of residual toner for each color, occurrence of running out of toner, or the like to the user as is required.

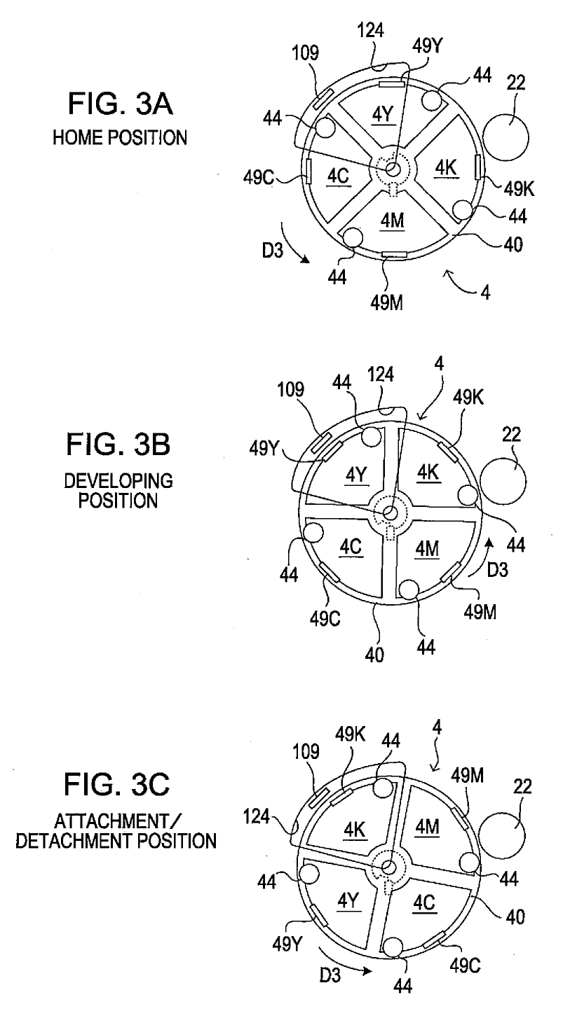

FIGS. 3A, 3B, and 3C are diagrams showing stop positions of the developing unit 4. The developing unit 4 is fixed in three types of positions, which are shown in FIGS. 3A, 3B, and 3C, by the developing unit driving motor 47 and the rotary lock 45. The three types of positions include: a home position; a developing position; and an attachment/detachment position. Among these positions, the home position is a position of the developing unit 4 positioned in a case where the image forming apparatus is in a standby state in which an image forming operation is not performed. As shown in FIG. 3A, the home position is a position in which all the developing rollers 44 provided in the developers 4Y and the like are apart from the photosensitive member 22.

The developing position is a position positioned at a time when the electrostatic latent image on the photosensitive member 22 is rendered visible in a selected color of toner. As shown in FIG. 3B, the developing roller (in the example shown in the figure, the developing roller 44 provided in the black developer 4K) provided on one developer is disposed to oppose the photosensitive member 22, and a predetermined development bias is applied to the developing roller, and thereby the electrostatic latent image is rendered visible with the toner.

The attachment/detachment position is a position positioned only at a time when an attachment/detachment operation of the developer is performed. When the developing unit 4 is positioned in the attachment/detachment position, as shown in FIG. 3A, one developer appears in an opening portion 124 provided on a side of an external casing of the image forming apparatus, and thereby the developer can be taken out through the opening portion 124. FIG. 3C shows a state in which the black developer 4K appears in the opening portion 124. In addition, a new developer can be installed in a support frame 40 in which a developer has not been installed. In the attachment/detachment position, all the developing rollers provided in the developers are in a position apart from the photosensitive member 22. As described above, when the developing unit 4 is positioned in the attachment/detachment position, only one developer appearing in the opening portion 124 can be taken out. In other words, when the developing unit 4 is in the home position shown in FIG. 3A or in the developing position shown in FIG. 3B, any developer cannot be taken out of the opening portion 124. Thus, there is no problem that the user damages the image forming apparatus by performing an operation for attaching or detaching the developer carelessly. In the image forming apparatus, the above-described developing position and the attachment/detachment position are set for four developers 4Y, 4M, 4C, and 4K.

When the developing unit 4 is positioned in the developing position, as shown in FIG. 3B, an antenna for wireless communication provided in one developer is positioned to oppose the antenna 109 for wireless communication on the main body side. Described with reference to the example shown in FIG. 3B, when the developing roller 44 of the developer 4K is in a position opposing the photosensitive member 22, an antenna 492Y for wireless communication provided in the developer 4Y that is located in a position adjacent to the developer 4K on the downstream side of the rotation direction D3 of the developing unit 4 relative to the developer 4K is located in a position opposing the antenna 109 for wireless communication on the main body side. In other words, wireless communication between the antenna 109 for wireless communication on the main body side and the antenna 492Y for wireless communication on the developer 4Y side is performed, and thereby information stored in a memory chip 491Y provided in the developer 4Y is read out. In addition, new information is recorded in the memory chip 491Y.

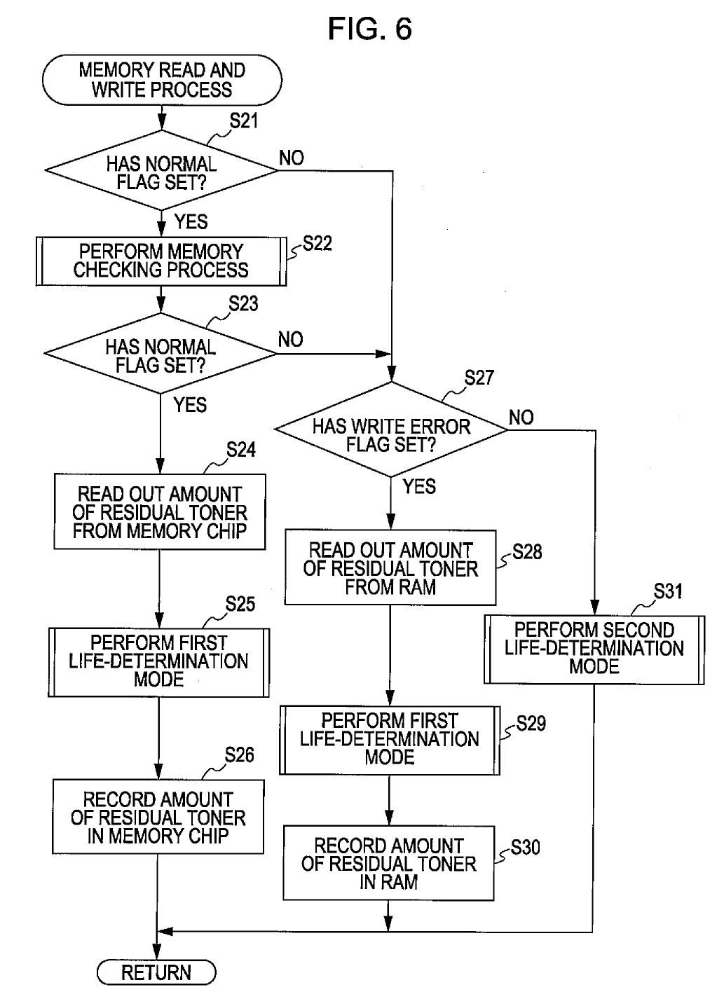

As described above, while a developing operation is performed using one developer (in FIG. 3B, the developer 4K), a read/write operation for a memory chip (in the developer 4Y, the memory chip 491Y) of a developer (in FIG. 3B, the developer 4Y) adjacent to the one developer is performed. When the developing operation is completed, the developing unit 4 is positioned in the home position after the read/write operation for a memory chip provided in a developer lastly used is performed. In other words, for example, when the developing operation is completed by developing using the developer 4K, the developer 4M is positioned to oppose the photosensitive member 22, the read/write operation for the memory chip 491K of the developer 4K is performed, and thereafter, the developing unit 4 is positioned in the home position. As described above, whenever a developer is used, a read/write operation for a memory chip of the developer is performed. The read/write operation for a memory chip is performed in the order shown in to-be-described FIG. 6.

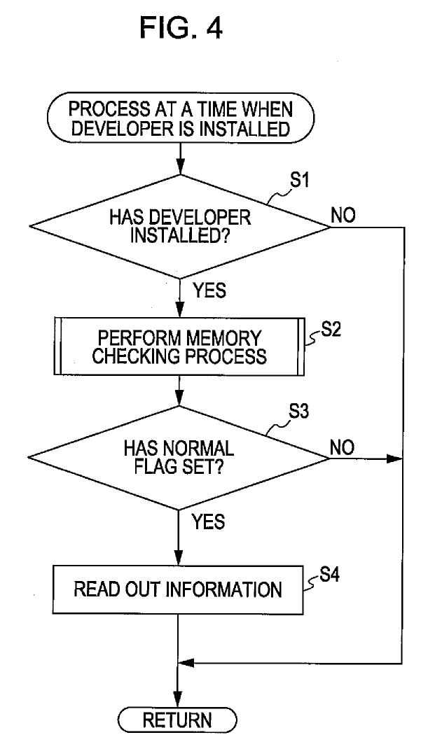

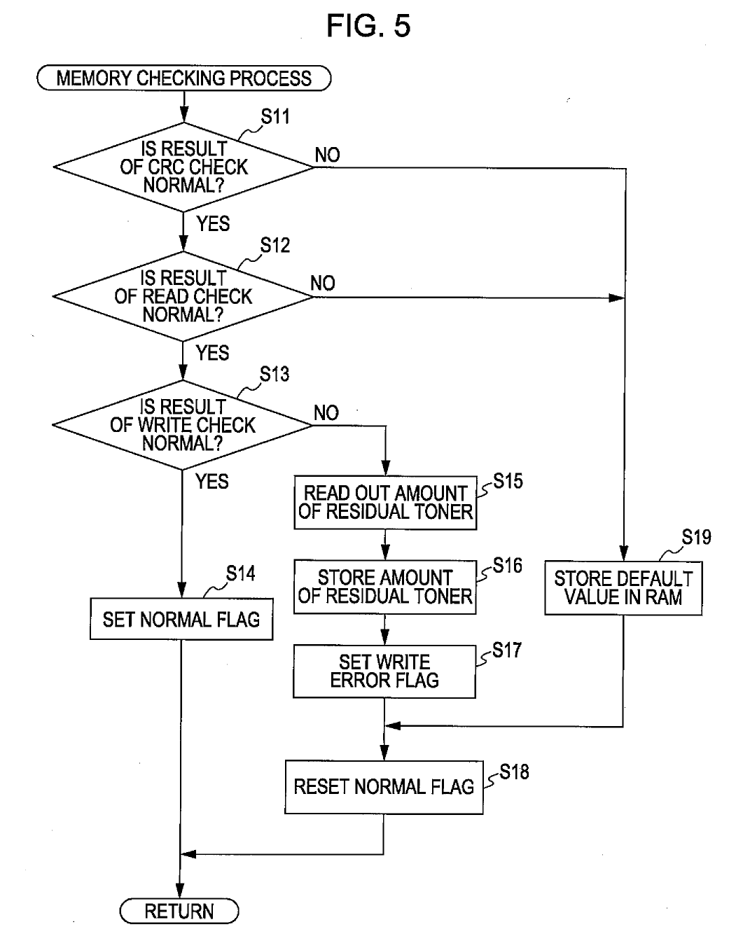

FIG. 4 is a flowchart showing an operation at a time when a developer is installed. FIG. 5 is a flowchart showing a subroutine for a memory checking process of Step S2 shown in FIG. 4. In this embodiment, when a new developer is installed (in Step S1: YES) in the main body 1 of the image forming apparatus, the CPU 101 performs a memory checking process for memory chips 491Y, 491C, 491M, and 491K (Step S2). In the memory checking process, as shown in FIG. 5, first, a CRC (Cyclic Redundancy Check) checking operation is performed so as to determine the memory chip is in a normal state (Step S11). By performing the CRC checking operation, it is determined whether the memory chip has a structure known to the CPU 101. When the result of CRC checking operation is normal (Step S11; YES), a read-out checking operation is performed (Step S12), and when the result of the read-out operation is normal (Step S12; YES), a write checking operation is performed (Step S13). Then, when the result of the write checking operation is normal (Step S13; YES), a normal flag, which indicates that the memory chip is in a normal state, is set in a predetermined area of the RAM 107 (Step S14), and the subroutine is ended.

On the other hand, when the results of the CRC checking operation and the read-out checking operation are normal (Step S11; YES and Step S12; YES), and only the write checking operation has an error (Step S13; NO), the memory chip has a structure known to the CPU 101, and it is possible to read out a stored value, and accordingly, information on the amount of residual toner is read out (Step S15), the information is stored in a predetermined area of the RAM 107 (Step S16), a write error flag, which indicates that only the result of the write operation has an error, is set (step S17), the normal flag is reset (Step S18), and the subroutine is ended.

When there is an error in the result of the CRC checking operation (Step S11; NO), the memory chip does not have a structure known to the CPU 101, and accordingly, there is a possibility that the stored value cannot be read out normally or the stored value is not reliable. When the result of the read-out checking operation has an error (Step S12; NO), the stored value cannot be read out. Thus, when the result of the CRC checking operation has an error (Step S11; NO) or the result of the read-out checking operation has an error (Step S12; NO), a preset default value is stored in the RAM 107 (Step S19) as the information on the amount of residual toner (Step S19), the normal flag is reset (Step S18), and this subroutine is ended. As the default value, for example, the amount of toner stored in a standard toner cartridge may be used.

When the subroutine for the memory checking process is ended, the process proceeds back to the process shown in FIG. 4, and it is determined whether the normal flag is set (Step S3). When the normal flag is set (Step S3; YES), the information stored in the memory chip is read out, and the information is stored in the RAM 107 as is required (Step S4). The read information includes information on the manufacturing lot or manufacturing date of the developer, information on the usage status of the developer (operating time, the number of attachment/detachment, a time stamp indicating a time when the developer has been taken out previously, or the like), and information on the amount of residual toner. However, the information may be some of the above-described information and may include information other than the above-described information.

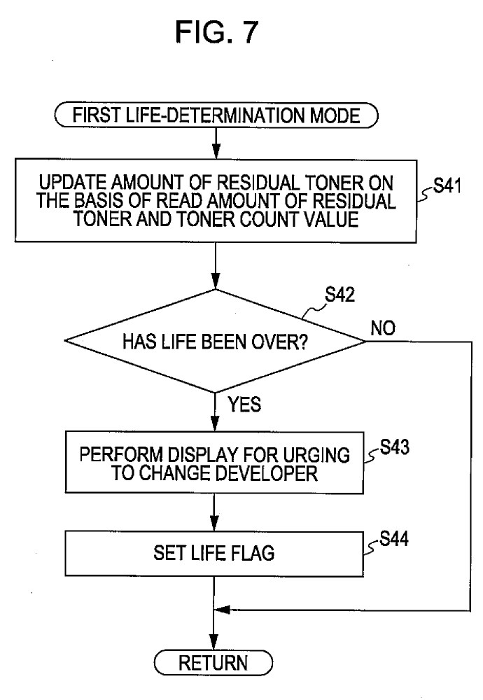

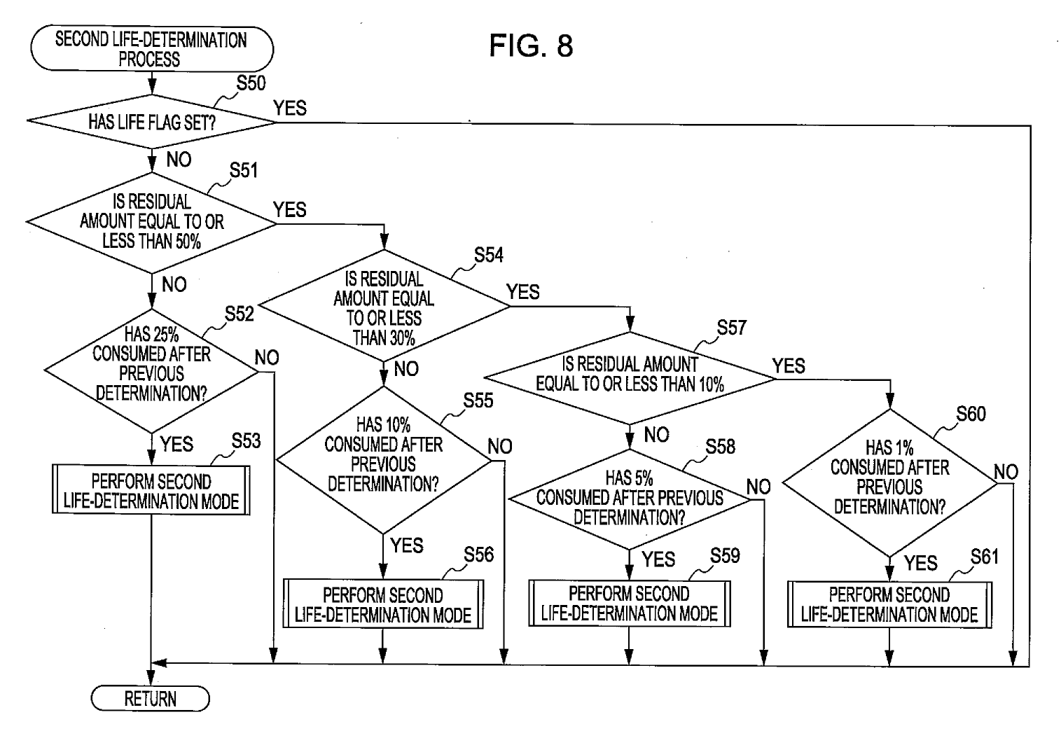

FIG. 6 is a flowchart showing read and write operations for a memory chip. FIG. 7 is a flowchart showing a subroutine for a first life-determination mode of Steps S25 and S29 shown in FIG. 6. FIG. 8 is a flowchart showing a subroutine for a second life-determination process of Step S31 shown in FIG. 6.

As shown in FIG. 6, first, the CPU 101 determines whether the normal flag is set in the RAM 107 (Step S21). When the normal flag is set (Step S21; YES), the above-described memory checking process is performed (Step S22). Thereafter, the CPU determines whether the normal flag is set in the RAM 107 again (Step S23). When the normal flag is set (Step S23; YES), the CPU reads out information including the amount of residual toner from the memory chip (Step S24) and performs a first life-determination mode using the amount of residual toner (Step S25).

In the first life-determination mode, the amount of residual toner is updated on the basis of the read-out amount of residual toner and the count value of the toner counter 200 (Step S41), and it is determined whether the life thereof is over on the basis of the updated amount of residual toner (Step S42). When the life is not over (Step S42; NO), the subroutine is ended. On the other hand, when the life is over (Step S42; YES), a message urging to replace the developer is displayed in the display unit 12 (Step S43), a life flag is set in a predetermined area of the RAM 107 (Step S44), and the subroutine is ended. Then, in Step S26 shown in FIG. 6, the updated amount of residual toner is recorded in the memory chip (Step S26), and this routine is ended.

On the other hand, when the normal flag is not set in the RAM 107 in Step S21 or Step S23 (Step S21; NO or Step S23; NO), the CPU 101 determines whether the write error flag is set in the RAM 107 (Step S27). When the write error flag is set (Step S27; YES), the CPU 101 reads out the amount of residual toner stored in the RAM 107 is (Step S28) and performs the first life-determination mode using the amount of residual toner (Step S29). Then, the updated amount of residual toner is recorded in the RAM 107 (Step S30), and this routine is ended.

On the other hand, in Step S27, when the write error flag is not set in the RAM 107 (Step S27; NO), a second life-determination mode shown in FIG. 8 is performed (Step S31), and this routine is ended.

This second life-determination process, as shown in FIG. 6, is performed when it is determined that the memory chip of the developer has an error in the CRC checking operation or the read-out checking operation. As shown in FIG. 5, a default value is stored in the RAM 107 as the amount of residual toner at a time when the error is determined.

In the second life-determination process, as shown in FIG. 8, first, it is determined whether the life flag is set in the RAM 107 (Step S50). When the life flag is set (Step S50; YES), this subroutine is ended. In other words, when it is determined that the life of the developer is over, the second life-determination process is not performed.

On the other hand, when the life flag is not set (Step S50; NO), it is determined whether the amount of residual toner is equal to or less than 50% (Step S51). In other words, the amount of residual toner stored in the RAM 107 is read out, the amount of residual toner is updated on the basis of the read amount of residual toner and the count value of the toner counter 200, and it is determined whether the updated amount of residual toner is equal to or less than 50% of the default value stored in the RAM 107. When the amount of residual toner exceeds 50% (Step S51; NO), in Step S52, it is determined whether the amount of toner consumption has reached 25% of the default value after the previous second life-determination mode is performed Step S53). When 25% has been consumed (Step S53; YES), the second life-determination mode is performed as described below (Step S53). In other words, while the amount of residual toner exceeds 50%, the second life-determination mode is performed for each 25% consumption of the toner (Step S53).

Similarly, when the amount of residual toner is in the range of 30% to 50% (Step S51; YES and Step S54; NO), the second life-determination mode (Step S56) is performed for each 10% consumption of toner (Step S55; YES). On the other hand, when the amount of residual toner is in the range of 10% to 30% (Step S54; YES and Step S57; NO), the second life-determination mode (Step S59) is performed for each 5% consumption of toner (Step S58; YES). In addition, when the amount of residual toner is equal to or less than 10% (Step S57; YES), the second life-determination mode (Step S61) is performed for each 1% consumption of toner (Step S60; YES).

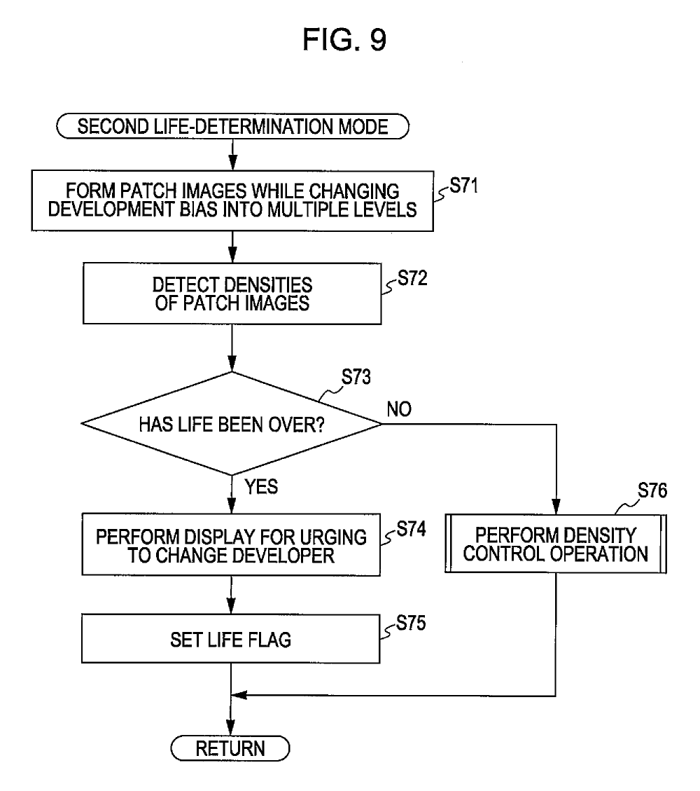

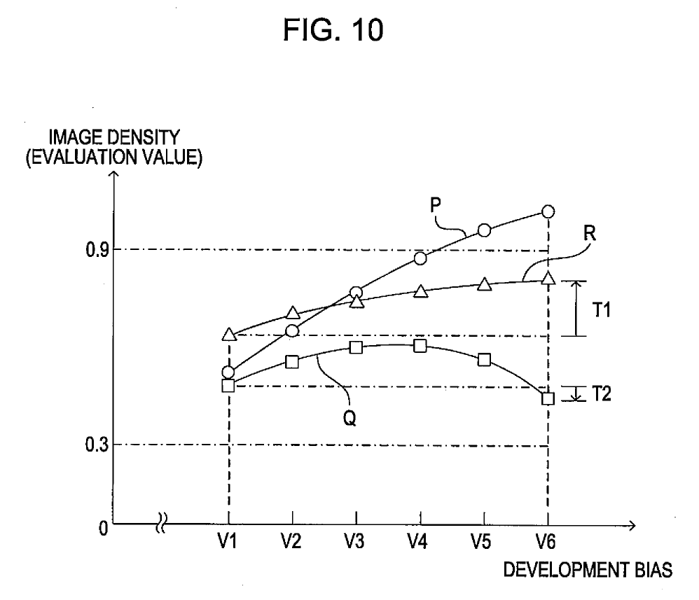

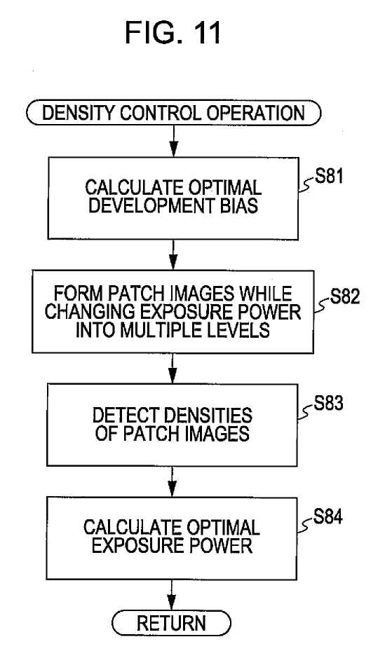

FIG. 9 is a flowchart showing a subroutine for the second life-determination mode performed in Steps S53, S56, 359, and S61 shown in FIG. 8. FIG. 10 is a diagram showing a relationship between a development bias and an image density. FIG. 11 is a flowchart showing a subroutine for a density control operation of Step S76 shown in FIG. 9.

In the second life-determination mode, as shown in FIG. 9, first, the development bias is changed into multiple levels (here, the development bias is gradually increased from the minimum bias value V1 to the maximum bias value V6 corresponding to total six levels), and, for example, beta images are formed by using patch images for each set level (Step S71). In the beta image, since the charged potential level of the photosensitive member 22 or the intensity of the light beam L emitted from the exposure unit 6 has a little effect on the image density, it is possible to adjust the development bias with high precision in an easy manner by using the patch images as the beta images. Then, the densities of the patch images are detected by the density sensor 60 (Step S72). Then, it is determined whether the life of the developer is over on the basis of the detected image density (Step S73). Here, the determination of the life will be described with reference to FIG. 10.

Here, as shown in FIG. 10, the image density is represented by using an evaluation value defined as follows. This evaluation value is represented in the range of “0” to “1” by normalizing the density of toner on the intermediate transfer belt 71. In other words, when toner is not attached to the intermediate transfer belt 71 at all, the evaluation value becomes “0”, and when the intermediate transfer belt 71 is fully covered with the toner, the evaluation value becomes “1”. In such a case, the toner image with the maximum density that can be attained by using the toner has the evaluation value of “1”. General evaluation values of toner images have values in the range of “0” to “1”.

When there is a sufficient amount of toner in the developer, as shown as a curve P in FIG. 10, the image density (evaluation value) increases in accompaniment with an increase in the development bias level. However, when the amount of residual toner decreases, as shown as a curve R, an increment T1 of the image density decreases even when the development bias level is increased. In a more severe case, as shown as a curve Q, while the development bias is increased, the image density may decrease, whereby the increment T2 of the image density comes to have a negative value. This occurs, since a small amount of residual toner is consumed for forming patch images formed first, and the amount of toner provided for development of the patch images formed later becomes insufficient.

Patterns of abnormal densities represented by the densities of patch images due to insufficient amount of residual toner includes:

(1) The density Dv(6) of the patch image formed by applying the maximum development bias V6 falls short of a predetermined density (for example, an evaluation value of 0.9);

(2) A difference between the density Dv(6) of a patch image formed by applying the maximum development bias V6 and the density Dv(1) of a patch image formed by applying the minimum development bias V1 is smaller than a predetermined value; and

(3) The density Dv(6) of a patch image formed by applying the maximum development bias V6 has a level equivalent to or less than the density Dv(1) of a patch image formed by applying the minimum development bias V1.

Of the above-described abnormal density patterns, by using a criterion on the basis of one or appropriate combined patterns, it is possible to determine whether the life of a developer is over.

When the life is over (Step S73; YES), a message urging to replace the developer is displayed in the display unit 12 (Step S74), the life flag is set in a predetermined area of the RAM 107 (Step S75), and the subroutine is ended. On the other hand, when the life is not over (Step S73; NO), a density control operation (Step S56) is performed, and the subroutine is ended. In the apparatus configured as shown in FIG. 1, density control operations are performed for each color of toner at a predetermined timing such as right after the power of the apparatus is turned on or right after return of the apparatus from a sleep state. Since there are many known technologies regarding the control operation performed after the power is turned on, a brief overview of the operation will be described here.

As shown in FIG. 11, first, an optimal development bias value is calculated (Step S81). In other words, on the basis of results of detected densities of path images formed by applying different bias values, a development bias value at which the density of the image matches a target density or becomes the closest to the target density is set as the optimal development bias value. Next, an operation for controlling the exposure power is performed. While the optimal development bias value acquired above is set as the development bias, the intensity (exposure power level) of the light beam emitted from the exposure unit 6 on the photosensitive member 22 is changed into multiple levels (here, four levels) for forming half-tone images as patch images (Step S82). Since the image density of the half-tone image changes large in accordance with the exposure power level, the control of the exposure power can be performed with high precision by using half-tone images as patch images. Then, the densities of the patch images are detected by the density sensor 60 (Step S83), and thereafter the optimal exposure power level is calculated on the basis of the results of detection (Step S84). Accordingly, optimal values of the development bias and the exposure power for one color of toner are acquired.

As described above, in this embodiment, the engine unit EG having the developers 4Y, 4C, 4M, and 4K and the photosensitive member 22 serve as an image forming unit according to an embodiment of the invention, and the CPU 101 serves as a memory determining unit, a life-determination unit, and a density control unit according to an embodiment of the invention. In addition, the developers 4Y, 4C, 4M, and 4K correspond to toner cartridges according to an embodiment of the invention, and the memory chips 491Y, 491C, 491M, and 491K provided in the developers correspond to cartridge memory units according to an embodiment of the invention.

As described above, in this embodiment, a CRC checking operation, a read-out checking operation, and a write checking operation are performed for the memory chips 491Y, 491C, 491M, and 491K provided in the developers 49Y, 49C, 49M, and 49K so as to determine whether their states are normal. When it is determined that all of their states are normal or there is an error only in the write checking operation, the life of the developer is determined by using the first life-determination mode that is performed on the basis of the count value of the toner counter 200. On the other hand, when it is determined that there is an error in the CRC checking operation or the read-out checking operation, the life of the developer is determined by using the second life-determination mode that is performed on the basis of the image densities of the patch images. Accordingly, the lives of the developers 49Y, 49C, 49M, and 49K can be determined appropriately regardless of occurrences of errors in the memory chips 491Y, 491C, 491M, and 491K. As a result, it can be prevented that recording paper or processing time is wasted due to an occurrence of image defect such as an occurrence of thin spots or insufficient density on an image that is caused at a time when a vast amount of images are consecutively formed while the amount of residual toner becomes insufficient.

In addition, according to this embodiment, as described with reference to FIG. 8, as the amount of residual toner decreases, the interval of performing the second life-determination mode is decreased, and accordingly, it is possible to prevent waste of recording paper or a processing time more assuredly.

In addition, according to this embodiment, as described with reference to FIG. 9, since the patch images are used for the life determination and density control, the patch images can be used effectively.

In addition, the present invention is not limited to the above-described embodiments, and various changes can be made therein without departing from the gist of the invention. For example, although, in the embodiment, the interval of performing the second life-determination is determined on the basis of the count value of the toner counter 200, the present invention is not limited thereto. For example, the interval of the second life-determination operations may be performed each time a predetermined number of images are formed or, a performing timing may be determined on the basis of, for example, an operational time of the developer, and more particularly, an operational time of the developer.

In addition, although in the embodiment, it is determined whether a memory chip is in a normal state on the basis of the CRC checking operation, the read-out checking operation, and the write checking operation, the checking method is not limited thereto. For example, the determination may be performed on the basis of only the read-out checking operation and the write checking operation.

In addition, although in the embodiment, the present invention is used for a color image forming apparatus using four colors Y, M, C, and K of toner, the present invention is not limited thereto and may be used for image forming apparatuses using different types of colors or a different number of the colors. For example, the present invention may be applied to a monochrome image forming apparatus.

What is claimed is:

1. An image forming apparatus comprising:
a toner cartridge that is configured to be detachably attachable to a main body of the image forming apparatus and stores toner;
a cartridge memory unit that is provided in the toner cartridge and stores information on the toner cartridge;
an image forming unit that forms a toner image using toner supplied from the toner cartridge;
a memory determining unit that determines whether the cartridge memory unit is in a normal state;
a count unit that counts an amount of toner consumption consumed for the toner image formed by the image forming unit; and
a life determination unit that determines the life of the toner cartridge corresponding to an amount of residual toner remaining in the toner cartridge,
wherein the life determination unit shifts its mode between a first life-determination mode in which the life is determined on the basis of a count value of the count unit and a second life-determination mode in which the life is determined on the basis of the toner density of a toner image used as a patch image formed by the image forming unit, on the basis of the result of determination of the memory determining unit.

2. The image forming apparatus according to claim 1,
wherein the memory determining unit performs the determination by a CRC checking operation, a read-out checking operation, and a write checking operation,
wherein the life determination unit performs the life determination operation by using the first life-determination mode in a case where the memory determining unit determines that the results of all the checking operations are normal or there is an error only in the result of the write checking operation, and performs the life determination operation by using the second life-determination mode in a case where the memory determining unit determines that there is an error in the result of the CRC checking operation or the result of the read-out checking operation.

3. The image forming apparatus according to claim 1, wherein the life determination unit determines a timing for performing the life determining operation in the second life-determining mode on the basis of the amount of toner consumption.

4. The image forming apparatus according to claim 3, wherein the life determination unit shortens an interval for performing the life determining operation in the second life-determination mode as a value corresponding to the amount of toner consumption increases.

5. The image forming apparatus according to claim 1, wherein the life determination unit does not perform the life determining operation after determining that the life is over as the result of the life determining operation in the second life-determination mode.

6. The image forming apparatus according to claim 1, further comprising a density control unit that performs a density control operation for adjusting an operation parameter of the image forming unit which has an effect on the density of the toner image on the basis of the density of a patch image when the life determination unit performs the life determination operation in the second life-determination mode and thus, the patch image is formed by the image forming unit.

7. The image forming apparatus according to claim 1,
wherein the main body of the image forming apparatus is configured such that a plurality of toner cartridges can be built therein;
wherein the memory determining unit determines whether the cartridge memory unit is in a normal state for each toner cartridge; and
wherein the life determination unit shifts between the first life-determination mode and the second life-determination for each toner cartridge on the basis of the result of determination performed by the memory determining unit.

8. A method of determining the life of a toner cartridge using an image forming apparatus that has a toner cartridge configured to be detachably attachable to a main body of the image forming apparatus and store toner and a cartridge memory unit provided in the toner cartridge and storing information on the toner cartridge and forms a toner image using toner supplied from the toner cartridge, the method comprising:
determining whether the cartridge memory unit is in a normal state;
counting an amount of toner consumption consumed for forming the toner image; and
determining the life of the toner cartridge corresponding to an amount of residual toner remaining in the toner cartridge,
wherein the determining of the life shifts its mode between a first life-determination mode in which the life is determined on the basis of a count value acquired by the counting of the amount of toner consumption and a second life-determination mode in which the life is determined on the basis of the toner density of a toner image formed as a patch image, on the basis of the result of determination of the determining of a state of the cartridge memory.
